(19) United States
(12) Patent Application Publication
(10) Pub. No.: US 2012/0155666 A1
(43) Pub. Date: Jun. 21, 2012

(54) ADAPTIVE NOISE CANCELLATION

(76) Inventor: Vijayakumaran V. Nair, Austin, TX (US)

(21) Appl. No.: 12/970,383

(22) Filed: Dec. 16, 2010

(51) Int. Cl. G10K 11/16

(52) U.S. Cl. 381/71.6

(57) ABSTRACT

In some embodiments a noise cancellation system includes a first digital microphone to detect ambient noise, a first sigma delta modulator coupled to an output of the first digital microphone, a second digital microphone located near an earpiece speaker to detect an output of the earpiece speaker, a second sigma delta modulator coupled to an output of the second digital microphone, a decimator coupled to the second sigma delta modulator, and an adaptive digital filter to adaptively adjust an output of the earpiece speaker in response to the decimator and the first sigma delta modulator so that the output of the earpiece speaker includes a desired audio and an acoustic signal to cancel some or all of the ambient noise. Other embodiments are described and claimed.

### RELATED APPLICATION

This application is related to U.S. patent application Ser. No. ______ entitled “ADAPTIVE NOISE CANCELLATION” to Vijayakumaran V. Nair and filed on even date herewith, Attorney Docket Number P31462.

### TECHNICAL FIELD

The inventions generally relate to adaptive noise cancellation.

### BACKGROUND

Acoustic noise cancellation in the earpiece of a portable device is typically implemented using traditional analog microphones. Digital microphone modules are beginning to become popular, but their use in adaptive noise cancellation (ANC) is very limited. Traditional solutions using analog microphones do not need to deal with delays caused by decimators that are made of higher order sinc filters, for example. However, these decimators may be needed to filter noise in the output of digital microphones. Therefore, a need has arisen to mitigate the effect of inherent delays of a decimator in an adaptive noise cancellation solution.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a system according to some embodiments of the inventions.

FIG. 5 illustrates a system according to some embodiments of the inventions.

FIG. 6 illustrates a system according to some embodiments of the inventions.

FIG. 7 illustrates a system according to some embodiments of the inventions.

### DETAILED DESCRIPTION

Some embodiments of the inventions relate to adaptive noise cancellation.

In some embodiments a noise cancellation system includes a first digital microphone to detect ambient noise, a first sigma delta modulator coupled to an output of the first digital microphone, a second digital microphone located near an earpiece speaker to detect an output of the earpiece speaker, a second sigma delta modulator coupled to an output of the second digital microphone, a decimator coupled to the second sigma delta modulator, and an adaptive digital filter to adaptively adjust an output of the earpiece speaker in response to the decimator and the first sigma delta modulator so that the output of the earpiece speaker includes a desired audio and an acoustic signal to cancel some or all of the ambient noise.

In some embodiments, at least one coefficient of the adaptive digital filter is used to adaptively adjust the output of the earpiece speaker based on a present error sample and a delayed input sample.

The inventions according to some embodiments relate to acoustic noise cancellation (ANC) in an earpiece of a portable device (for example, according to some embodiments, a cell phone, a mobile Internet device or MID, personal digital assistants or PDAs, etc.) According to some embodiments as described herein, noise cancellation is described in reference to only one earpiece. However, according to some embodiments, noise cancellation is applied to two or more earpieces such as a left earpiece and a right earpiece of a stereo headset, for example.

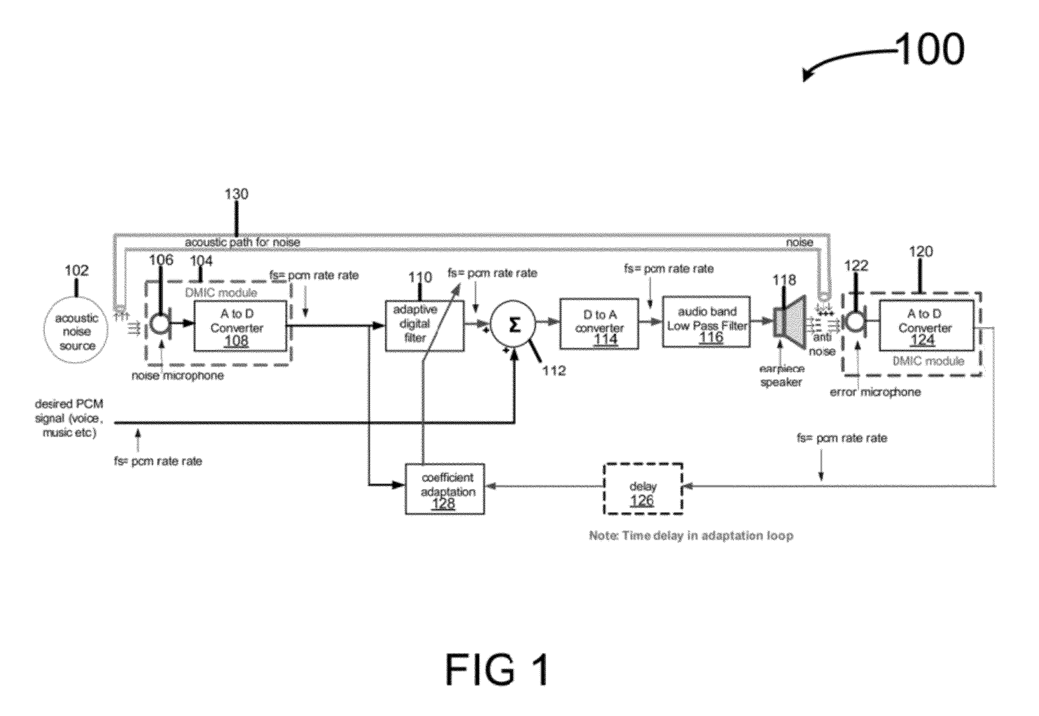

FIG. 1 illustrates a system 100 according to some embodiments of the inventions. In some embodiments, system 100 implements an adaptive noise cancellation (ANC) solution.

According to some embodiments, in many implementations of a system such as system 100 that includes earpieces, microphones, etc., ambient noise exists in the surroundings of a person listening to a desired audio signal which is input to the system (for example, as pulse code modulation or PCM samples which may be sampled at one or several standard sampling rates such as 8 k samples per second, 16 k samples per second, 44.1 k samples per second, 48 k samples per second, and/or 96 k samples per second, etc.) Without a noise cancellation scheme, the user will hear both the desired audio and the noise that is passing through the acoustic path and being added to the speaker output. According to some embodiments, a noise cancellation scheme such as system 100 illustrated in FIG. 1, for example, employs digital signal processing.

According to some embodiments, system 100 includes an acoustic noise source 102, a digital microphone module (DMIC module) 104 that includes a noise microphone 106 and an analog to digital converter (A to D converter or A/D converter) 108, a filter 110 (for example, an adaptive digital filter), an adder 112, a digital to analog converter (D to A converter or D/A converter) 114, an audio band low pass filter (LPF) 116, a speaker 118 (for example, an earpiece speaker), a digital microphone module (DMIC module) 120 that includes an error microphone 122 and an analog to digital converter (A to D converter or A/D converter) 124, a delay (and/or delay module) 126, and a coefficient adaptation module 128. In some embodiments, adaptive digital filter 110, adder 112, D to A converter 114, audio band LPF 116, earpiece speaker 118, DMIC module 120, error microphone 122, A to D converter 124, delay module 126, and/or coefficient adaptation module 128 form an adaptation loop that provides a time delay.

In some embodiments, system 100 illustrated in FIG. 1 provides acoustic noise cancellation in an earpiece of a portable device such as, for example, one or more cell phones, mobile Internet devices (MIDs), personal digital assistants (PDAs) and/or other portable devices. Although noise cancellation is described in reference to FIG. 1 as being performed in one earpiece, according to some embodiments the same and/or similar principles are applied in two or more earpieces (for example, according to some embodiments, applied to both left and right earpieces of a stereo headset).

According to some embodiments, in many implementations of a system such as system 100 that includes earpieces, microphones, etc., ambient noise exists in the surroundings of a person listening to a desired audio signal which is input to the system (for example, as pulse code modulation or PCM samples which may be sampled at one or several standard sampling rates such as 8 k samples per second, 16 k samples per second, 44.1 k samples per second, 48 k samples per second, and/or 96 k samples per second, etc.) Without a noise cancellation scheme, the user will hear both the desired audio and the noise that is passing through the acoustic path and being added to the speaker output.

The noise is illustrated as originating on the left side of FIG. 1 from the acoustic noise source 102. The noise passes through an acoustic path 130 and reaches the ear canal of a listener. The acoustic path is through air and the handset enclosure and reaches up to the point where the speaker 118 is located. The speaker 118 reproduces the sound of the signal coming from the far end along with a modified version of the acoustic noise picked up by the microphone 106 located near the noise source 102. In some embodiments it is noted that the sound of the signal can be voice or an audio signal from the far end, or can also be an audio signal that is stored (for example, in a local multimedia card).

As illustrated in FIG. 1, according to some embodiments an earpiece in a handset, for example, uses and/or includes two microphones 106 and 122. Noise microphone 106 is placed away from the speaker 118 and picks up ambient noise. In some embodiments, error microphone 122 is physically placed inside the earpiece in a location close to the speaker 118 and/or close to the ear canal of the listener when the handset is placed against the listener's ear, for example. According to some embodiments system 100 is used in an implementation of an earpiece located in a headset. Thus, according to some embodiments, noise microphone 106 does not sense the desired audio and only senses the ambient noise.

According to some embodiments, signals from both microphones 106 and 122 are simultaneously sampled at a chosen and/or convenient sampling rate. According to some embodiments, the output of the noise microphone 106 is passed through the filter 110, and the filter 110 has a frequency response (both in amplitude and phase) which is identical to the acoustic path 130 through which the noise traverses from the ambient through the earpiece's enclosure up to the point where the speaker 118 is located. However, the characteristics of the acoustic path 130 are unknown, and may vary in time due to various factors such as ambient temperature and the orientation of the handset. Once the coefficients of the digital filter 110 have been adjusted and the ANC system 100 is stabilized, it is expected that the output of filter 110 when converted to an audible signal through the speaker 118 will ideally be equal in magnitude to the unwanted noise, but opposite in polarity. This output is referred to as “anti-noise” and will cancel to a minimum the noise in the ear canal of the listener. In practice, the residual signal (or error signal) after cancellation may not be zero, however. The resulting audio noise (the residual error signal) is sampled and digitized using the error ADC 124. That is, noise at the output of the earpiece is sensed by the error microphone 122, and a corresponding output of the A to D converter 124 is used to modify the filter coefficients cycle by cycle until the error signal is reduced to a minimum level. The error ADC samples are used to iteratively modify coefficients of the filter until the coefficients stabilize and the error level reaches a minimum value (not necessarily zero). This is accomplished by the time delay in the adaptation loop formed by filter 110, adder 112, LPF 16, speaker 118, DMIC module 120, error microphone 122, A to D converter 124, delay 126, and/or coefficient adaptation 128.

It is noted that time delay 126 is not really a functional or physical block. In some embodiments time delays are inherent (for example inherent in a decimator), and the data transportation process between the DMIC, the decimator, and the coefficient adaptation blocks. These delays are lumped together as a block in FIG. 1 to illustrate that there is a finite time delay in the signal path.

According to some embodiments, this adaptive filtering is implemented using a least mean square (LMS) error implementation using, for example, a finite impulse response (FIR) digital filter. This may be accomplished as described in the following equations.

$$y ( n ) = {\sum }_{k = 0}^{N - 1} ( h ( k ) * x ( n - k ) \qquad ( Equation A )$$

where
   y(n) is the current output sample
   x represents the present and past N−1 samples of the noise microphone's digital output samples
   N is an integer (equal to 128 in some embodiments)

e(n)=d(n)−y(n) (Equation B)
where
   d(n) is current sample of acoustic noise (not measured separately)
   e(n) is the current digital sample of the output of the error microphone

hₖ(n+1)=hₖ(n)+μ*e(n)*x(n−k) (Equation C)
where
   k is an integer ranging from 0 to N−1 and p is a parameter that controls the step size with which the coefficients are modified.

Another implementation according to some embodiments in which to update coefficients is using an LMS sign implementation is as follows.

hₖ(n+1)=hₖ(n)+Δ*sign(e(n)*x(n−k)) (Equation D)

where Δ is the step size used to update the coefficients

According to some embodiments, in the above equations A, B, C, and/or D, it is assumed that the output of the error microphone 122 is sampled and digitized and without any delay is used to update the coefficients to estimate the next output sample of the FIR filter to evaluate equation A. The adaptive filter will converge quickly by choosing the right values for p and/or for Δ. However, if the error signal is delayed by more than two sampling intervals of the FIR filter before it is used to update the coefficients, the filter may not converge when the noise is of a random nature (such as unwanted audible speech or sound).

An implementation of an adaptive filter using digital microphone modules employing oversampled sigma delta modulators (ΣΔ modulators) for sensing the acoustic noise and acoustic error signals as well as to drive the speaker may be used. Sigma delta modulators may be used for ND converters for acoustic noise and error signals as well as the D/A converter that drives the speaker. However, the use of sigma delta modulators with corresponding decimators and interpolators introduces additional delays in the signal paths, which can cause convergence problems.

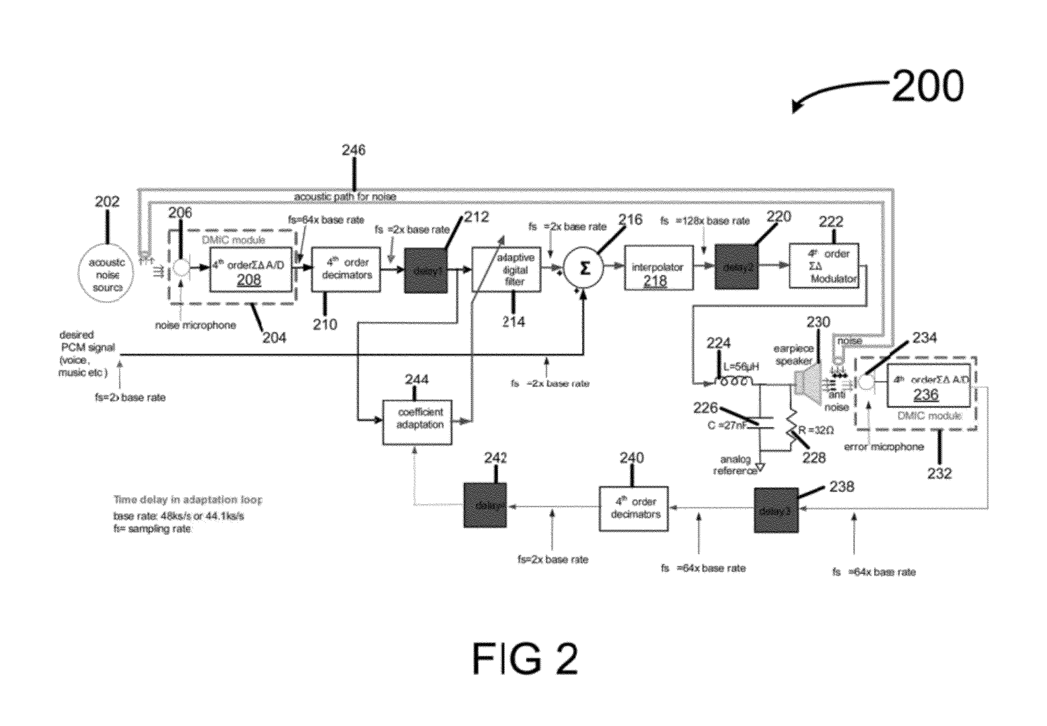

FIG. 2 illustrates a system 200 according to some embodiments of the inventions. In some embodiments, system 200 implements an adaptive noise cancellation (ANC) solution. In some embodiments, system 200 includes an adaptive noise cancellation implementation using analog to digital converters (A/Ds) and digital to analog converters (D/As) using sigma delta modulators.

According to some embodiments, system 200 includes an acoustic noise source 202, a digital microphone module (DMIC module) 204 that includes a noise microphone 206 and a fourth order sigma delta analog to digital modulator 208, fourth order decimators 210, delay 212, a filter 214 (for example, an adaptive digital filter and/or finite impulse response or FIR filter), an adder 216, an interpolator 218, delay 220, a fourth order sigma delta digital to analog modulator 222, an inductor 224, a capacitor 226, a resistor 228, a speaker 230 (for example, an earpiece speaker), a digital microphone module (DMIC module) 232 that includes an error microphone 234 and a fourth order sigma delta analog to digital modulator 236, delay 238, fourth order decimators 240, delay 242, and a coefficient adaptation module 244. In some embodiments, adaptive digital filter 214, adder 216, interpolator 218, delay 220, fourth order sigma delta modulator 222, inductor 224, capacitor 226, resister 228, earpiece speaker 230, DMIC module 232, error microphone 234, fourth order sigma delta modulator 236, delay 238, fourth order decimators 240, delay 242, and/or coefficient adaptation module 244 form an adaptation loop that provides a time delay.

The noise is illustrated as originating on the left side of FIG. 2 from the acoustic noise source 202. The noise passes through an acoustic path 244 and reaches the ear canal of a listener. The acoustic path is through air and the handset enclosure and reaches up to the point where the speaker 230 is located. The speaker 230 reproduces the music of voice signal coming from the far end along with a modified version of the acoustic noise picked up by the microphone 206 located near the noise source 202.

Digital microphone modules have been replacing analog microphones in many handset designs due to their small size and the possibility of higher levels of integration. Most digital microphones (and/or DMICs) in the market employ a micro electro mechanical (MEM) sensor or electric microphone to convert acoustic signals to electrical signals followed by, for example, a fourth order oversampled sigma delta modulator (ΣΔ modulator) that produces a one bit stream at the output, for example.

According to some embodiments, the sigma delta modulator (ΣΔ modulator) 222 has a sampling rate of, for example, 64×PCM rate (i.e., 3.072 msamples/sec) if the PCM rate is 48 ksamples/sec (48 ks/sec). The output of the ΣΔ modulator is low pass filtered, to suppress the high frequency quantization noise, typically using a sinĉ^{(order+1)} filter where order is the order of the ΣΔ modulator. Here the order is 4, for example.

A sinc filter is provided according to the following.

$${y}_{dec} ( n ) = {\{ \frac{( 1 + {z}^{- Nd} )}{( 1 - {z}^{- 1} )} \}}^{4} \qquad ( Equation E )$$

where
   y_{dec}(n) is the decimator output with an output sampling rate=input rate/Nd which in our case is 96 ksamples/sec with Nd=32, for example

Since most DMICs only specify a dynamic range of less than 90 dB and a signal to noise ratio of less than 65 dB, the sinc decimators can have an order that is the same as that of the ΣΔ modulator without adversely affecting the performance of the DMICs. According to some embodiments, system 200 is an adaptive noise cancellation (ANC) implementation with all blocks integrated within the same integrated circuit (IC).

According to some embodiments, the decimated output of the noise ΣΔ modulator 210 is passed through an adaptive finite impulse response (FIR) filter or a cascade of FIR and infinite impulse response (IIR) filters in order to modify the output to resemble the acoustic noise that appears at the earpiece speaker 230. According to some embodiments, system 200 includes a FIR with 128 taps, which can have a very wide range in implementation. The desired audio signal is up sampled from the input sampling rate and brought to the same rate as that of the noise decimator and then added to the output of the adaptive FIR filter. The combined sum of audio and adaptively filtered noise is interpolated in a linear interpolator to raise the over sampling ratio (OSR) to a high enough value before applying the signal to a ΣΔ modulator based digital to analog converter 222.

According to some embodiments, fourth order ΣΔ modulator digital to analog converter 222 employs an OSR of 128 and produces a one bit output stream. This one bit output drives the earpiece speaker 230 through a second order low pass filter formed by the LC network including the inductor 224 and the capacitor 226. If the adaptive filter has converged satisfactorily, the speaker output will produce an acoustic signal to cancel the noise so that the error microphone 234 that is fixed in front of the speaker 230 will pick up a minimum audible error signal. According to some embodiments, a noise rejection of at least 10 dB is achieved.

It is noted that delay blocks 212, 220, 238 and/or 242 illustrated in FIG. 2 represent possible delays that may be unavoidable during data transfer from one stage to the next. According to some embodiments these delays may be set to zero (no delay), for example, when the implementation is within the same integrated circuit (IC). However, according to some embodiments, certain delays are systemic and unavoidable.

According to some embodiments, the fourth order sinc function is a cascade of four sinc stages and will have a group delay as expressed in the following equation.

$$decimator output delay = \frac{Nd}{2 * {f}_{dsm}} * 4 \\ where {f}_{dsm} is the sampling rate of the input . \qquad ( Equation F )$$

According to some embodiments, the interpolator output will have a delay of one sampling period of its input sampling rate. This delay in FIG. 2, for example, is 1/(2× pcm rate)=10.417 μsec if the pcm rate is chosen as 48 ks/sec.

According to some embodiments, loop delay in the signal loop (adaptation loop) formed by adaptive digital filter 214, adder 216, interpolator 218, delay 220, fourth order sigma delta modulator 222, inductor 224, capacitor 226, resister 228, earpiece speaker 230, DMIC module 232, error microphone 234, fourth order sigma delta modulator 236, delay 238, fourth order decimators 240, delay 242, and/or coefficient adaptation module 244 can only tolerate, for example, about 20 μsec or 2 samples periods of the adaptive filter. Since the interpolator already takes about 10 μsec, this critical path only has about 10 μsec left to accommodate the delays in other elements in the signal path. These include the LC based LPF including inductor 224 and capacitor 226, the speaker 230, the error microphone 234, the sinc decimator of the ΣΔ modulator 236 that converts the analog output of the error microphone 234 to a one bit digital stream, and any processing delays necessary to implement the adaptive filter. In some embodiments, the DMIC 232 may also include a fourth order sinc filter which would have a delay according to equation 6 above. This delay is, for example, 20.8 μsec for a PCM rate of 48 ks/s (48 ksamples per second) and use of digital microphones that employ fourth order ΣΔ modulators in an ANC implementation becomes very limited. This delay restriction for the ANC loop is critical mainly when the noise signal is of a random nature. If the noise has a predictable repetitive pattern the loop delay becomes less critical. In addition to delay due to the error decimator, the other delays mentioned above may add additional delay (for example, from 2 to 5 μsec) depending on the number of taps in the adaptive filter, the bandwidth of the LC LPF, and any delay in the data transfer between functional blocks.

According to some embodiments, adaptive noise cancellation (ANC) is implemented in an audio codec that is part of a portable device made of multiple chips (for example, including a System on Chip or SoC and a mixed signal IC or MSIC). In some embodiments, digital microphone module (DMIC module) 204, noise microphone 206, fourth order sigma delta analog to digital modulator 208, fourth order decimators 210, delay 212, filter 214 (for example, an adaptive digital filter), adder 216, delay 242, and/or coefficient adaptation module 244 are included in an SoC. In some embodiments, interpolator 218, delay 220, fourth order sigma delta digital to analog modulator 222, inductor 224, capacitor 226, resistor 228, speaker 230, digital microphone module (DMIC module) 232, error microphone 234, fourth order sigma delta analog to digital modulator 236, delay 238, and/or fourth order decimators 240 are included in an MSIC.

In order to reduce the overall cost and silicon area of the total solution, there is a need to place digital functional blocks in the digital chip as much as possible. According to some embodiments, the digital filters (not illustrated in FIG. 2) that process the desired audio signals and the adaptive 128 FIR filter (for example, filter 214) must be implemented in an SoC that is built using an advanced Complementary Metal Oxide Semiconductor (CMOS) process. However, the SoC has pin limitations and the decimator outputs (16 to 24 bit samples, for example) from the MSIC to the SoC and the interpolator input from the SoC to the MSIC have to undergo parallel to serial and serial to parallel conversions and transfer between the two chips. This data transfer introduces additional delays in the critical loops of the ANC implementation, making it even more difficult to use digital microphones (DMICs) in such an implementation. According to some embodiments an acceptable solution is implemented that overcomes problems caused by the delays discussed above.

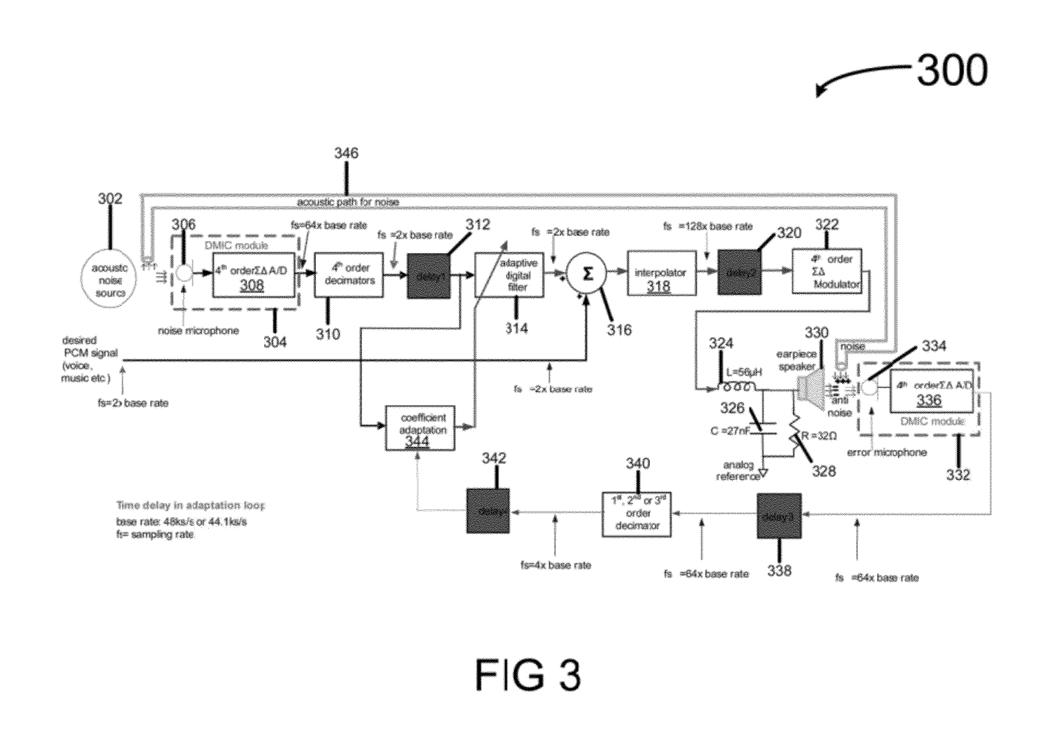

FIG. 3 illustrates a system 300 according to some embodiments of the inventions. In some embodiments, system 300 implements an adaptive noise cancellation (ANC) solution. In some embodiments, system 300 includes an adaptive noise cancellation implementation using analog to digital converters (A/Ds) and digital to analog converters (D/As) using sigma delta modulators.

According to some embodiments, system 300 includes an acoustic noise source 302, a digital microphone module (DMIC module) 304 that includes a noise microphone 306 and a fourth order sigma delta analog to digital modulator 308, fourth order decimators 310, delay 312, a filter 314 (for example, an adaptive digital filter), an adder 316, an interpolator 318, delay 320, a fourth order sigma delta digital to analog modulator 322, an inductor 324, a capacitor 326, a resistor 328, a speaker 330 (for example, an earpiece speaker), a digital microphone module (DMIC module) 332 that includes an error microphone 334 and a fourth order sigma delta analog to digital modulator 336, delay 338, first, second, and/or third order decimators 340, delay 342, and a coefficient adaptation module 344. In some embodiments, adaptive digital filter 314, adder 316, interpolator 318, delay 320, fourth order sigma delta modulator 322, inductor 324, capacitor 326, resister 328, earpiece speaker 330, DMIC module 332, error microphone 334, fourth order sigma delta modulator 336, delay 338, fourth order decimators 340, delay 342, and/or coefficient adaptation module 344 form an adaptation loop that provides a time delay.

The noise is illustrated as originating on the left side of FIG. 3 from the acoustic noise source 302. The noise passes through an acoustic path 346 and reaches the ear canal of a listener. The acoustic path is through air and the handset enclosure and reaches up to the point where the speaker 330 is located. The speaker 330 reproduces the sound of voice or music signals coming from the far end along with a modified version of the acoustic noise picked up by the microphone 306 located near the noise source 302.

The delay problem discussed above can be significantly reduced by using a traditional analog microphone for the error signal and a fast ND converter that does not introduce undesirable delays (that is, eliminating the decimator in the error signal path). However, that is not a desirable choice. Therefore, another way to implement an error decimator according to some embodiments includes using an error decimator with a sampling rate that is twice a traditional rate (that is, for example, using 4×PCM rate rather than 2×PCM rate). This reduces decimator delay from, for example, 20.8 μsec to 10.4 μsec if a fourth order sinc filter is used. However, even 10.4 μsec does not leave enough spare time for the LC filter, data transfer between the SoC and the MSIC, and/or processing time for implementing the FIR filter. Therefore, further modification to the error decimator may be made to the error decimator to reduce its order from 4 to 2, for example, providing a delay of 5.208 μsec, for example. Although use of a second order SINC filter may be unacceptable for traditional decimators that accompany a fourth order ΣΔ modulator, it use in adaptation control gives satisfactory levels of noise cancellation, even when desired audio is present while the adaptation process is in progress (that is, equivalent to “double talk” during adaptive echo cancellation). According to some embodiments, a first order sinc decimator keeps the adaptive filter operational, although noise rejection may not be quite as good as with a second or third order sinc filter.

According to some embodiments, decimator 340 is a first order decimator. According to some embodiments, decimator 340 is a second order decimator. According to some embodiments, decimator 340 is a third order decimator. According to some embodiments, decimator 340 is a first order decimator, a second order decimator, or a third order decimator used in series with a ΣΔ modulator for the error signal.

According to some embodiments, the effect of inherent delays of a decimator may be mitigated in the proper operation of an ANC implementation. In some embodiments, different sampling rates are used for the noise path and the error path. According to some embodiments, a sinc decimator is used which has a lower order than an order of an associated ΣΔ modulator used in the implementation.

According to some embodiments, sigma delta modulators and decimators are used in an adaptive noise cancellation (ANC) implementation where a sampling rate that is twice the sampling rate of other implementations. According to some embodiments, sigma delta modulators and decimators are used in an adaptive noise cancellation (ANC) implementation where a first, second or third order sinc filter is used in an error decimator block rather than a fourth or fifth order sinc filter. According to some embodiments, a sufficient time duration is allowed to pass data between a mixed signal chip and an SoC which implements more complex audio digital signal processing (DSP) operations using a state of the art silicon process. According to some embodiments, an adaptive finite impulse response (FIR) filter includes a number of taps (for example, 128 taps) and/or is in an SoC which features a high clock frequency (for example, of greater than 200 MHz). According to some embodiments, the SoC takes less than 2 μsec for all related arithmetic operations, leaving 3 μsecs for data transfers between the chips as well as to accommodate the group delay of the LC based low pass filter (LPF). The LC filter typically has a 3 dB corner of 130 kHz and a group delay of about 1.3 μsecs.

According to some embodiments, adaptive noise cancellation (ANC) implementations include digital microphones (DMICs) that use sigma delta modulators (ΣΔ modulators) and decimators to sense the acoustic noise and error signals.

According to some embodiments, a unique sampling rate is used and/or an order of the sinc filter for the error signal path is implemented.

According to some embodiments, adaptive noise cancellation (ANC) is implemented in an audio codec that is part of a portable device made of multiple chips (for example, including a System on Chip or SoC and a mixed signal IC or MSIC). In some embodiments, digital microphone module (DMIC module) 304, noise microphone 306, fourth order sigma delta analog to digital modulator 308, fourth order decimators 310, delay 312, filter 314 (for example, an adaptive digital filter), adder 316, delay 342, and/or coefficient adaptation module 344 are included in an SoC. In some embodiments, interpolator 318, delay 320, fourth order sigma delta digital to analog modulator 322, inductor 324, capacitor 326, resistor 328, speaker 330, digital microphone module (DMIC module) 332, error microphone 334, fourth order sigma delta analog to digital modulator 336, delay 338, and/or first, second, or third order decimators 340 are included in an MSIC.

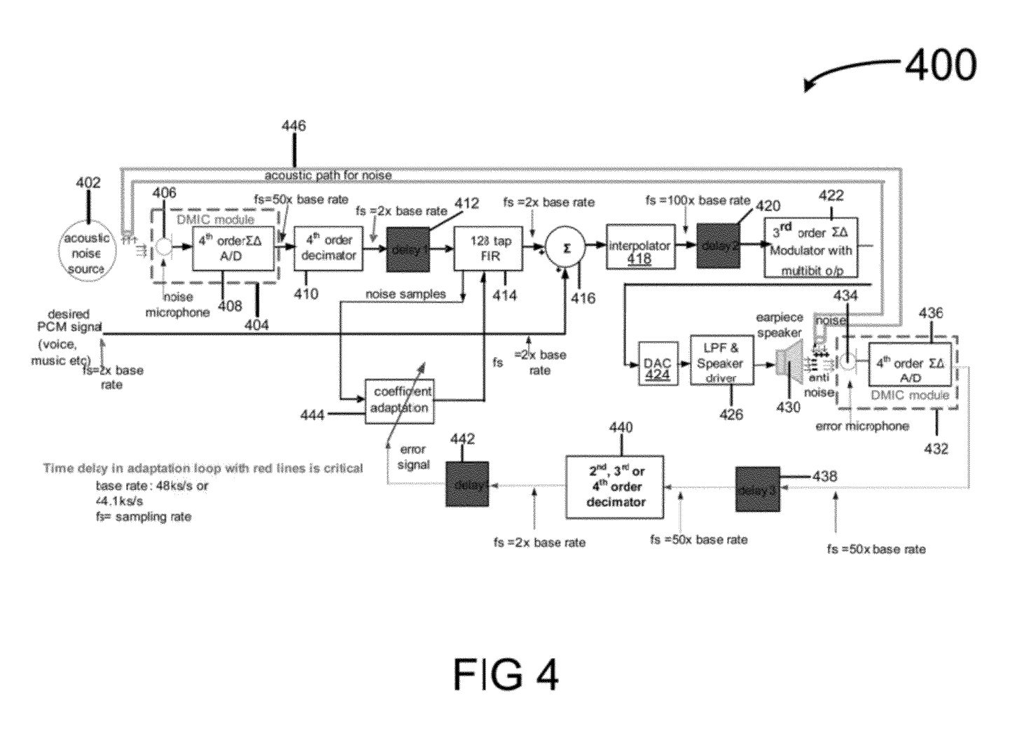

FIG. 4 illustrates a system 400 according to some embodiments of the inventions. In some embodiments, system 400 implements an adaptive noise cancellation (ANC) solution. In some embodiments, system 400 includes an adaptive noise cancellation implementation using analog to digital converters (A/Ds) and digital to analog converters (D/As) using sigma delta modulators (ΣΔ modulators).

According to some embodiments, system 400 includes an acoustic noise source 402, a digital microphone module (DMIC module) 404 that includes a noise microphone 406 and a fourth order sigma delta analog to digital modulator 408, fourth order decimator 410, delay 412, a filter 414 (for example, an adaptive digital filter, a finite impulse response filter or FIR filter, and/or a 128 tap FIR), an adder 416, an interpolator 418, delay 420, a third order sigma delta modulator with multibit output 422, a digital to analog converter (DAC) 424, a low pass filter (LPF) and speaker driver 426, a speaker 430 (for example, an earpiece speaker), a digital microphone module (DMIC module) 432 that includes an error microphone 434 and a fourth order sigma delta analog to digital modulator 436, delay 438, second, third, or fourth order decimators 440, delay 442, and a coefficient adaptation module 444. In some embodiments, filter 414, adder 416, interpolator 418, delay 420, third order sigma delta modulator 422, DCA 424, LPF and speaker driver 426, earpiece speaker 430, DMIC module 432, error microphone 434, fourth order sigma delta A/D modulator 436, delay 438, second, third, or fourth order decimator 440, delay 442, and/or coefficient adaptation module 444 form an adaptation loop that provides a time delay.

The noise is illustrated as originating on the left side of FIG. 4 from the acoustic noise source 402. The noise passes through an acoustic path 446 and reaches the ear canal of a listener. The acoustic path is through air and the handset enclosure and reaches up to the point where the speaker 430 is located. The speaker 430 reproduces the music of voice signal coming from the far end along with a modified version of the acoustic noise picked up by the microphone 406 located near the noise source 402.

As discussed above, digital microphone modules have been replacing analog microphones in many handset designs due to their small size and the possibility of higher levels of integration. Most digital microphones (DMICs) in the market employ a micro electro mechanical (MEM) sensor or electric microphone to convert acoustic signals to electrical signals followed by, for example, a fourth order oversampled sigma delta modulator (ΣΔ modulator) that produces a one bit stream at the output, for example.

According to some embodiments, the sigma delta modulator (ΣΔ modulator) 422 has a sampling rate of, for example, 50×PCM rate (i.e., 2.4 Msamples/sec) if the PCM rate is 48 ks/sec. The output of the ΣΔ modulator is low pass filtered to suppress the high frequency quantization noise, typically using a sinĉ^{(order+1)} filter where order is the order of the ΣΔ modulator.

Since most available DMICs specify only a dynamic range of less than 90 dB and a signal to noise ratio of less than 65 dB, the sinc decimators can have an order that is the same as that of the ΣΔ modulator without adversely affecting the performance of the DMICs.

As discussed previously, a since filter is implemented according to equation E, for example. In some implementations of FIG. 4, for example, Nd=25, and the output rate is 96 ksamples/sec.

The decimated output of the noise ΣΔ modulator is passed through the adaptive FIR filter 414 or a combination of FIR and IIR filters in order to modify it to resemble the acoustic noise that appears at the earpiece speaker 430. FIG. 4 illustrates an FIR with 128 taps, although the number of taps may have a very wide range that depends on the characteristics of the noise, handset enclosure, path delays, etc. The desired audio signal such as “far end voice signal” is up sampled from the input sampling rate and brought to the same rate as that of the noise decimator and then added to the output of the adaptive FIR filter. The combined sum of audio and adaptively filtered noise is interpolated in a linear interpolator such as interpolator 418 to raise the over sampling rate (OSR) to a high enough value before applying the interpolated signal to a ΣΔ modulator based Digital to Analog Converter (DAC). System 400 of FIG. 4 uses a third order ΣΔ modulator DAC with OSR of 100, and produces a 5 bit output stream with 17 distinct levels, for example. The 5 bit output is converted to analog units using a DAC 424 and a low pass filter (LPF) 426. The output of the LPF 426 is passed through a power amplifier to drive the speaker (for example, a 32 ohms speaker) that produces the acoustic anti-noise along with the desired audio or voice signal.

It is noted that the functions that convert the interpolator 418 output through the DCA 424 to the speaker driver 426 output can be formed by different manners, including using a fourth or fifth order ΣΔ modulator, a semi-digital FIR or IIR LPFs, pulse wave modulation (PWM) generators with LPF using LC filters; etc. If the adaptive filter has converged satisfactorily, the speaker output will produce an acoustic signal to cancel the noise so that the error microphone 434 that is fixed in front of the speaker 430 will pick up a minimum audible error signal. According to some embodiments, the goal of the system 400 design is to achieve a noise rejection of at least 10 dB.

It is noted that delay blocks 412, 420, 438 and/or 442 illustrated in FIG. 4 represent possible delays that may be unavoidable during data transfer from one stage to the next. According to some embodiments these delays may represent the actual implementation or processing delays in the arithmetic operations as well as the delays associated with data transfer between functional blocks in system 400. It is noted that some delays are systemic and unavoidable.

According to some embodiments, the fourth order sinc function is implemented by a combination of four integrators in series with four discriminators. A group sinĉ4 decimator delay may be calculated according to equation F set forth above. According to some embodiments, the sampling rate f_{dsm} of the input of system 400 is 2.4 Ms/sec, and the Nd decimation factor is 25.

According to some embodiments, the interpolator output will have a delay of one sampling period of its input sampling rate. This delay in FIG. 4, for example, is 1/(2× pcm rate)=10.417 μsec if the pcm rate is chosen as 48 ks/sec.

According to some embodiments, delay in the signal loop (adaptation loop) formed by adaptive digital filter 414, adder 416, interpolator 418, delay 420, third order sigma delta modulator 422, DAC 424, LPF and speaker driver 426, earpiece speaker 430, DMIC module 432, error microphone 434, fourth order sigma delta modulator 436, delay 438, second, third, or fourth order decimator 440, delay 442, and/or coefficient adaptation module 444 must be, for example, less than 2 sample periods of the adaptive filter (about 21 μsec) for the ANC system 400 closed loop to be stable. This includes delays in the error microphone 434, the sinc decimator of the modulator 436 that converts the analog output of the error microphone 434 to a one bit digital stream, and any processing delays necessary to implement the adaptive filter. In some embodiments, the DMIC 432 may also include a fourth or fifth order sinc filter with a delay according to equation 6 above. This delay is, for example, 20.8 μsec for a PCM rate of 48 ks/s (48 ksamples per second) and use of digital microphones that employ fourth order ΣΔ modulators in an ANC implementation becomes very limited. This delay restriction for the ANC loop is critical mainly when the noise signal is of a random nature. If the noise has a predictable repetitive pattern the loop delay becomes less critical. In addition to delay due to the error decimator, the other delays mentioned above may add additional delay (for example, from 2 to 5 μsec) depending on the number of taps in the adaptive filter and any delay in the data transfer between functional blocks.

According to some embodiments, adaptive noise cancellation (ANC) is implemented in an audio codec that is part of a portable device made of multiple chips (for example, including a System on Chip or SoC and a mixed signal IC or MSIC). In some embodiments, digital microphone module (DMIC module) 404, noise microphone 406, fourth order sigma delta analog to digital modulator 408, fourth order decimators 410, delay 412, filter 414, adder 416, delay 442, and/or coefficient adaptation module 444 are included in an SoC. In some embodiments, interpolator 418, delay 420, third order sigma delta digital to analog modulator 422, DAC 224, LPF and speaker driver 426, speaker 430, digital microphone module (DMIC module) 432, error microphone 434, fourth order sigma delta analog to digital modulator 436, delay 438, and/or second, third, or fourth order decimator 440 are included in an MSIC.

In order to reduce the overall cost and silicon area of the total solution, there is a need to place digital functional blocks in the digital chip as much as possible. According to some embodiments, the digital filters (not illustrated in FIG. 4) that process the desired audio signals and the adaptive 128 FIR filter (for example, filter 414) must be implemented in an SoC that is built using an advanced Complementary Metal Oxide Semiconductor (CMOS) process. However, the SoC has pin limitations and the decimator outputs (16 to 24 bit samples, for example) from the MSIC to the SoC and the input from the SoC to the MSIC have to undergo parallel to serial and serial to parallel conversions and transfer between the two chips. This data transfer introduces additional delays in the critical loops of the ANC implementation, making it even more difficult to use digital microphones (DMICs) in such an implementation. If FIG. 4 included typical A/D and D/A converters with negligible data conversion delays instead of ΣΔ modulators, then LMS would work-satisfactorily. However, delays in data transfer between functional blocks that are spread between multiple ICs along with the delays associated with ΣΔ modulators in the DMICs makes adding a feature of acoustic noise cancellation in portable devices such as cell phone, MID platforms, PDAs, etc. very difficult. These delays are solved according to some, embodiments.

As described above (for example, in reference to FIG. 3), adverse effects due to the delay in the error decimator can be significantly reduced by reducing the order of the error decimator (for example to two or three from four), and by increasing the output rate of the decimator (for example, from 96 ks/s to 192 ks/s). This helps reduce the delay from 2 to ½ or ¾ sample periods, for example, but does require a high speed data transfer between the SoC and the MSIC, for example. Additionally, it may require the delays due to other components to be less than 1.25 sample periods along the error signal path. According to some embodiments, this may be improved by implementing coefficient adaptation (for example, within an adaptive filter such as the adaptive FIR filter 414).

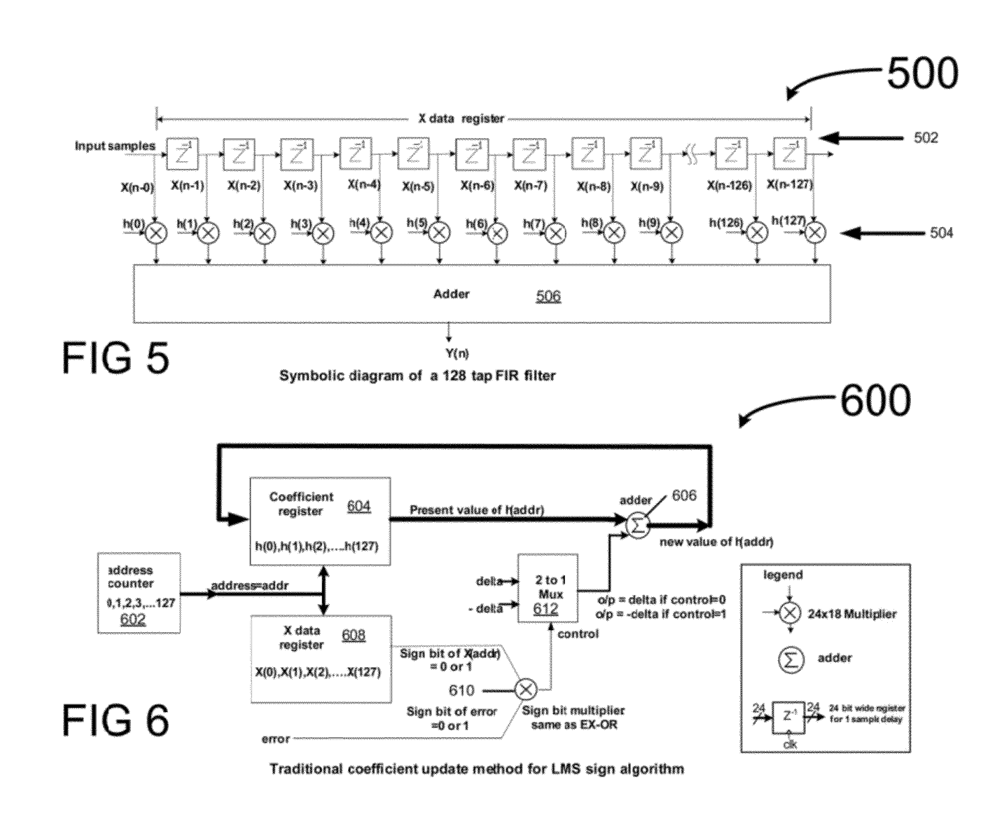

FIG. 5 illustrates a system 500 according to some embodiments of the inventions. According to some embodiments, system 500 is a filter (for example, a 128 tap FIR filter). In some embodiments, system 500 is a filter implemented based on equation A set forth above. System 500 includes a number of registers 502 (for example, according to some embodiments, 128 24 bit wide registers for one sample delay), multipliers 504 (for example, 128 24×18 multipliers), and an adder 506.

FIG. 6 illustrates a system 600 according to some embodiments of the inventions. According to some embodiments, system 600 illustrates a coefficient update implementation based on equation D set forth above. System 600 includes an address counter 602, a coefficient register 604, an adder 606, a data register 608, a multiplier 610, and a multiplexer 612.

In some implementations, the error signal in equation D and/or FIG. 6 experiences too much delay before being used to update the coefficients. The first coefficient h(0) is updated based on the first sample of data input delay line and the error signal. However, if the input sample has disappeared or moved to the next delay register in FIG. 6 when the error sample is available, then the resulting modification of the h(0) may become erroneous. Therefore, in some embodiments, it may be more appropriate to Modify h(0) based on the present sample of error and a delayed input sample such as X(n−1) or X(n−2), etc. In some embodiments, the actual offset delay for the input sample can be chosen as a function of the delay that the error signal may experience with a very wide range. Therefore, according to some embodiments, equation D may be modified as follows.

hₖ(n+1)=hₖ(n)+Δ*sign(e(n)*x(n−k−j)) (Equation G)
k=0, 1, 2, 3, 127
j is assigned a value from a set of integers (for example, from 0 to 8) depending on delay experienced by error signal e(n)

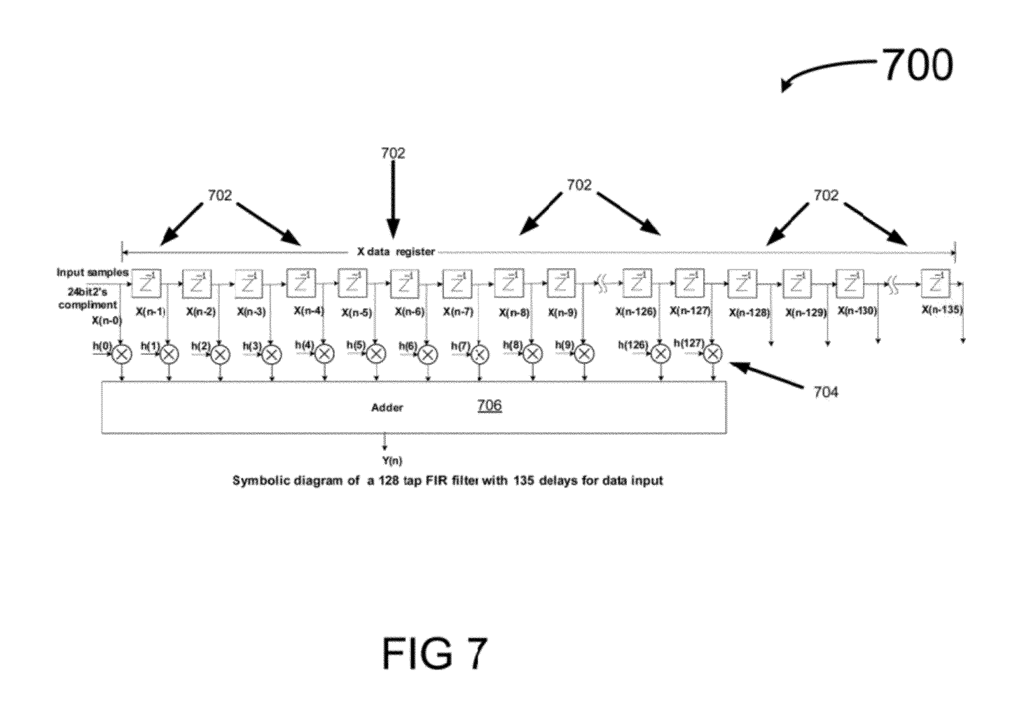

FIG. 7 illustrates a system 700 according to some embodiments of the inventions. According to some embodiments, system 700 is a filter (for example, a 128 tap FIR filter). In some embodiments, system 700 is a filter implemented based on equation G set forth above. System 700 includes a number of registers 702 (for example, according to some embodiments, 136 24 bit wide registers for one sample delay, 128 plus 8 registers), multipliers 704 (for example, 128 24×18 multipliers), and an adder 706.

System 700 illustrates a 128 tap FIR filter based on the implementation described in reference to equation G. The FIR filter remains the same as the filter illustrated in FIG. 5, except that the data register length has been increased by a number of additional samples (8 additional samples specifically illustrated in FIG. 7). The additional delayed samples store the sign bits if the sign implementation is employed, although a similar operation may be implemented according to an LMS implementation such as that set forth, for example, in equation C. As illustrated in FIG. 7, coefficient adaptation may be implemented based on equation G. In some embodiments, variable j in equation G is a programmable value that is based on the delay in the error signal path.

According to some embodiments, an FIR filter sampling rate is 88.2 ks/s and a delay in the error signal path including the fourth order decimator delay is approximately 36 μsec, setting j to a value of 5, 6, or 7 provides a satisfactory operation with respect to loop stability and noise rejection.

Implementations according to some embodiments and as described in reference to equation G and/or FIG. 7 allow for a wide range for delay in the error signal path as long as a sufficient number of register bits are allotted for the sign bits of noise samples. Additionally, such implementations may even allow a lower sampling rate for the error decimator than that of the noise decimator.

If a regular LMS algorithm is implemented using a Ntap FIR filters, N−1 data registers are necessary. However, according to some embodiments an extra “j” delays are added. This means that full word registers are added, not just the sign bits. However, if we are implementing LMS sign bit algorithm, only sign bits of the 127+j digital samples need to be stored. In some embodiments either “single bit” registers or “full word registers” (i.e., 16 bit to 24 bit word samples) are used. According to some embodiments, there is not a mix of full length registers and single bit registers. Such a mix may be used for the sign algorithm if we view from a different point of view such that sign algorithm only looks at the sign bit of the data in the register, even if the register has a full word. In a CPU based implementation, it may be more practical to use standard registers rather than single bit registers. In an implementation based on custom hardware design, the use of single bit registers for LMS sign algorithm will save a lot of gates.

According to some embodiments use of DMICs that integrate ΣΔ modulators are used while minimizing delays in the error signal loop. According to some embodiments, a smaller order sinc function operating at a higher sampler rate is used. In some embodiments, a few more register bits are added as part of the data register of the FIR filter. It is noted that in some embodiments LMS sign implementations are used and additional delays indicated by variable j only need to store and shift the sign bits, not the entire digital word (which may be in 16 bit to 24 bit samples).

According to some embodiments, digital microphones (DMICs) use ΣΔ modulators and decimators to sense the acoustic noise and error signals. Use of such DMICs causes issues that are not apparent in systems using analog microphones. In some embodiments, adaptive FIR filters are used which include extra delay elements. If the FIR filter is a N tap filter, the filter typically would have (N−1) data registers. According to some embodiments, FIR filters are implemented that use (N−1) data registers and j sign bit registers as well as an offset address register. According to some embodiments, FIR coefficients are updated in a new and unique manner (for example, by adding extra delay elements).

Although some embodiments have been described herein as being implemented in a certain way (such as with a 128 tap filter), according to some embodiments these particular implementations may not be required. For example, according to some embodiments, a different type or size of filter may be used.

It is noted that the time delays illustrated in this application are not really functional or physical blocks. In some embodiments time delays are inherent (for example inherent in a decimator), and the data transportation process between the DMIC, the decimator, and the coefficient adaptation blocks. These delays are illustrated in the figures to show that there is a finite time delay in the signal path. The delays in the system model diagrams illustrated herein represent inherent delays that will be in the system due to specific implementations of the decimators and interpolators, delays associated with parallel/serial/parallel conversions, delays necessary to hold data in registers for data synchronizations etc. Indeed, according to some embodiments, adverse effects of these delays on the performance of the adaptive filter system are solved.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A noise cancellation apparatus comprising:
a first digital microphone to detect ambient noise;
a first sigma delta modulator coupled to an output of the first digital microphone;
a second digital microphone located near an earpiece speaker to detect an output of the earpiece speaker;
a second sigma delta modulator coupled to an output of the second digital microphone;
a decimator coupled to the second sigma delta modulator;
an adaptive digital filter to adaptively adjust an output of the earpiece speaker in response to the decimator and the first sigma delta modulator so that the output of the earpiece speaker includes a desired audio and an acoustic signal to cancel some or all of the ambient noise, wherein at least one coefficient of the adaptive digital filter is used to adaptively adjust the output of the earpiece speaker based on a present error sample and a delayed input sample.

2. The noise cancellation apparatus of claim 1, wherein the adaptive digital filter includes data registers, sign bit registers, and an offset address register to adaptively adjust the output of the earpiece speaker based on the present error sample and the delayed input sample.

3. The noise cancellation apparatus of claim 1, wherein the delayed input sample is a delayed noise sample.

4. The noise cancellation apparatus of claim 1, wherein sampling rates of the ambient noise provided to the adaptive digital filter and of an output of the decimator are twice that of a base rate.

5. The noise cancellation apparatus of claim 1, wherein the first sigma delta modulator is a sigma delta analog-to-digital modulator and the second sigma delta modulator is a sigma delta analog-to-digital modulator.

6. The noise cancellation apparatus of claim 1, further comprising one or more decimators coupled between the first sigma delta modulator and the adaptive digital filter.

7. The noise cancellation apparatus of claim 1, further comprising an adder to combine an output of the adaptive digital filter and the desired audio.

8. The noise cancellation apparatus of claim 1, wherein the adaptive digital filter is to mitigate delays of the decimator.

9. The noise cancellation apparatus of claim 1, further comprising a sigma delta modulator coupled between an output of the adaptive digital filter and an input of the earpiece speaker.

10. The noise cancellation apparatus of claim 1, further comprising inherent delays due to one or more decimators, interpolators, parallel/serial/parallel conversions, and/or holding data in registers for data synchronization.

11. The noise cancellation apparatus of claim 1, wherein sampling rates of the ambient noise provided to the adaptive digital filter and of an output of the decimator are higher than that of a base rate

12. A method of noise cancellation comprising:
detecting an ambient noise with a first digital microphone;
sigma delta modulating an output of the first digital microphone;
detecting an output of an earpiece speaker with a second digital microphone;
sigma delta modulating an output of the second digital microphone;
decimating the sigma delta modulated output of the second digital microphone;
adaptively adjusting an output of the earpiece speaker in response to the decimating and the sigma delta modulating of the output of the first digital microphone so that the output of the earpiece speaker includes a desired audio and an acoustic signal to cancel some or all of the ambient noise, wherein the adaptively adjusting of the output of the earpiece speaker is based on a present error sample and a delayed input sample.

13. The method of claim 12, wherein the adaptively adjusting the output of the earpiece speaker based on the present error sample and the delayed input sample is performed in response to data, sign bits, and an offset address.

14. The method of claim 12, wherein the delayed input sample is a delayed noise sample.

15. The method of claim 12, further comprising sampling the ambient noise at a sampling rate that is twice that of a base rate and decimating the sigma delta modulated output of the second digital microphone at the sampling rate that is twice that of the base rate.

20. The method of claim 15, further comprising adaptively adjusting the output of the earpiece speaker in response to the desired audio.

21. The method of claim 15, further comprising mitigating delays in the decimating.

22. The method of claim 15, further comprising sampling the ambient noise at a sampling rate that is higher than that of a base rate and decimating the sigma delta modulated output of the second digital microphone at a sampling rate that is higher than that of the base rate.
